(19) United States
(12) Patent Application Publication
(10) Pub. No.: US 2012/0300095 A1
(43) Pub. Date: Nov. 29, 2012

(54) IMAGING APPARATUS AND IMAGING METHOD

(75) Inventor: Keiichi Sawada, Kawasaki-shi (JP)

(73) Assignee: CANON KABUSHIKI KAISHA, Tokyo (JP)

(21) Appl. No.: 13/477,488

(22) Filed: May 22, 2012

(30) Foreign Application Priority Data
May 27, 2011 (JP) 2011-119078

(51) Int. Cl. H04N 5/228

(52) U.S. Cl. 348/222.1; 348/E05.031

(57) ABSTRACT

A super-resolution capability is enhanced when a distance to a principal object is set as a synthetic focal distance. The principal object is extracted from images imaged by a plurality of imaging units, and a super-resolution capability of the extracted principal object is calculated. An imaging parameter is adjusted according to the calculated super-resolution capability.

### BACKGROUND OF THE INVENTION

1. Field of the Invention

The present invention relates to an imaging apparatus and an imaging method which obtain photographed image data from multiple viewpoints.

2. Description of the Related Art

There has been proposed an imaging apparatus which obtains photographed image data from a plurality of different viewpoints (for example, “Dynamically Reparameterized Light Fields”, A. Isaksen et al., ACM SIGGRAPH, pp. 297-306 (2000)). The imaging apparatus has a plurality of imaging parts, and obtains photographed image data from the plurality of different viewpoints by the each imaging part respectively performing photographing. Additionally, by synthesizing the each photographed image data after photographing, can be generated image data of a focal distance different from a focal distance set at the time of photographing (hereinafter referred to as a photographing focal distance). The above-described imaging apparatus is referred to as a camera array in the present invention (it is also known as camera array system, multiple lens camera, and the like).

Generally, in a camera array in which small imaging parts are arranged, an individual imaging part has few number of pixels due to its small size, and has a low resolution of photographed image data. Super-resolution processing has been known as a method for obtaining a piece of high-resolution image data from the above-described plural pieces of low-resolution image data (for example “Super-Resolution Image Reconstruction: A Technical Overview”, Sung C. P., Min K. P., IEEE Signal Proc. Magazine, Vol 26, 3, p. 21-36 (2003)).

In order to perform super-resolution processing in the camera array, pixel shift of sub-pixels (namely, pixel shift less than 1 pixel) needs to exist between photographed image data by each imaging part. However, there is a case where pixel shift of the sub-pixels does not occur between the photographed image data by the each imaging part depending on a focal distance set at the time of image synthesis (hereinafter referred to as a synthetic focal distance), and thus it may become impossible to perform super-resolution processing. When there is a principal object within the above-described distance where super-resolution processing cannot be performed, only low-resolution synthetic image data can be generated even though image data is synthesized in which the distance to the principal object is set as a synthetic focal distance.

In order to solve such a problem, in Japanese Patent Laid-Open No. 2009-206922, a capability of super-resolution processing is increased by changing an imaging parameter, such as a focal distance of optical system (hereinafter referred to as an optical focal distance) only by a random amount for each imaging part at the time of photographing. However, since a change amount of the imaging parameter is a random one, super-resolution processing cannot be always performed when the distance to the principal object is set as the synthetic focal distance.

### SUMMARY OF THE INVENTION

An object of the present invention is to increase a super-resolution capability when a distance to a principal object is set as a synthetic focal distance.

An imaging apparatus according to the present invention is characterized by including: a plurality of imaging units configured to perform photographing from a plurality of different viewpoints; an extracting unit configured to extract a principal object from images imaged by the imaging units; a calculating unit configured to calculate a super-resolution capability for the extracted principal object; and an adjusting unit configured to adjust an imaging parameter according to the calculated super-resolution capability.

According to the present invention, can be provided an imaging apparatus and an imaging method which can increase a super-resolution capability when a distance to a principal object is set as a synthetic focal distance.

Further features of the present invention will become apparent from the following description of exemplary embodiments (with reference to the attached drawings).

### BRIEF DESCRIPTION OF THE DRAWINGS

FIG. 1 is a diagram showing an exterior configuration of an imaging apparatus of an embodiment of the present invention;

FIG. 2 is a diagram showing the relationship between

FIGS. 2A and 2B;

FIGS. 2A and 2B illustrate a block diagram showing each processing part of the imaging apparatus;

FIG. 3 is a diagram showing details of an imaging part;

FIG. 4 is a flow chart showing operations of an imaging apparatus in an embodiment 1;

FIG. 5 is a flow chart showing operations of an image synthesis part;

FIG. 6 is an illustration schematically showing a photographed image group on which alignment processing has been performed;

FIG. 7 is a flow chart of the alignment processing;

FIG. 8 is an illustration showing a scale relation between a sensor and an object;

FIG. 9 is a flow chart showing operations of an imaging apparatus in an embodiment 2; and

FIG. 10 is an illustration schematically showing one example of warning display in a display part 206.

### DESCRIPTION OF THE EMBODIMENTS

### Embodiment 1

### <Entire Configuration of Imaging Apparatus>

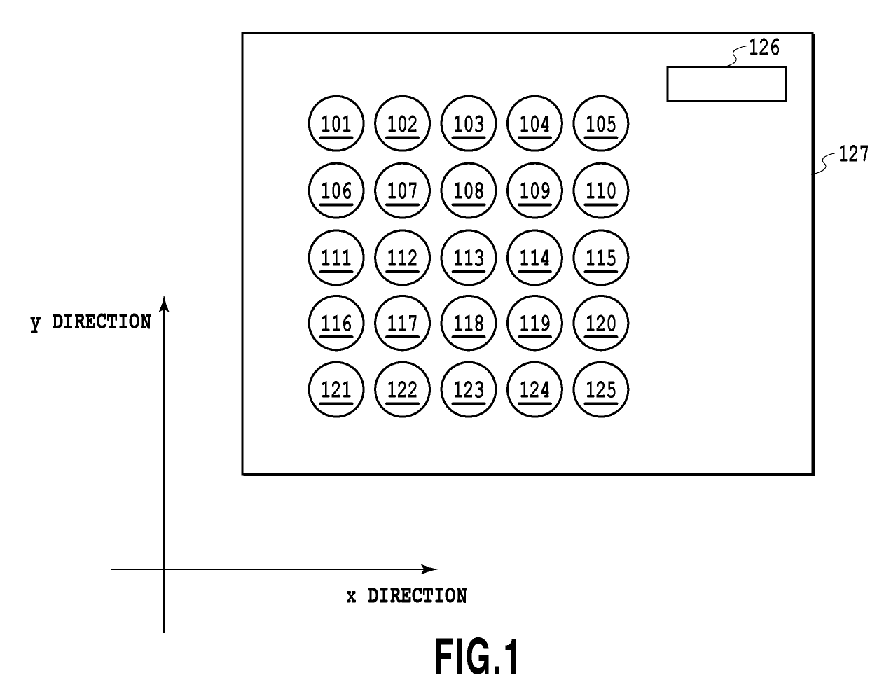

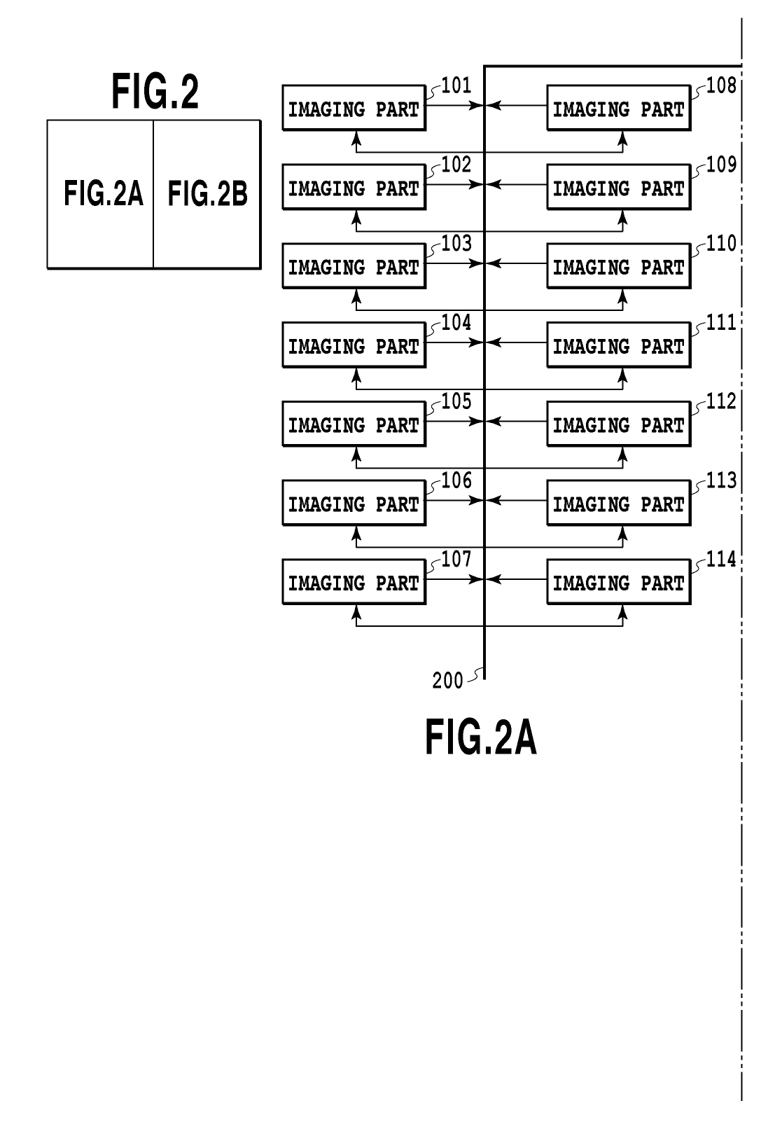

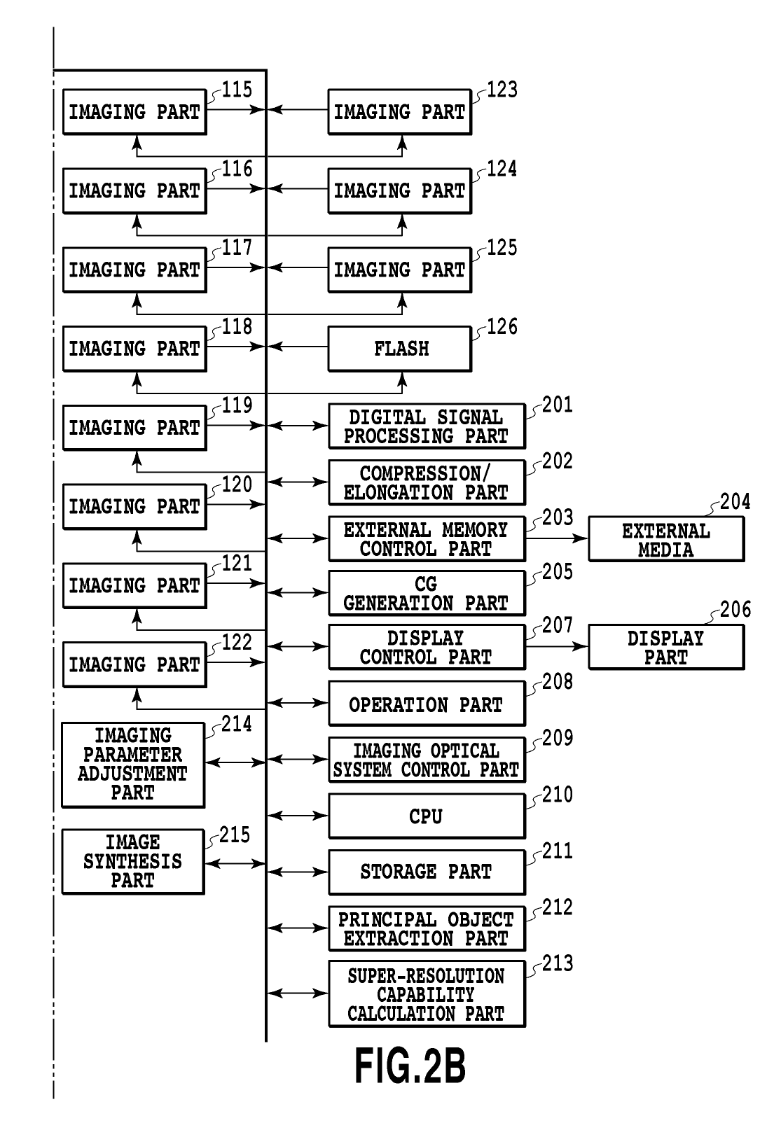

FIG. 1 is an exterior of a so-called camera array (imaging apparatus) having twenty-five imaging parts incorporated therein of an embodiment of the present invention. However, the number of imaging parts may be two or more, and the number of imaging parts is not limited to twenty-five in the present invention. Reference numerals 101 to 125 in FIG. 1 denote imaging parts. Photographing from a plurality of different viewpoints can be performed by the imaging parts 101 to 125. Reference numeral 126 denotes a flash. Reference numeral 127 denotes a camera body. In addition to that, an operation part, a display part, etc. which are not shown in FIG. 1 are provided in the exterior of the camera array, and they will be described using FIGS. 2A and 2B.

FIGS. 2A and 2B represent each processing part of the camera array of FIG. 1. Reference numeral 200 denotes a bus, which is a path for data transfer. The imaging parts 101 to 125 output photographed image data (hereinafter also referred to as a photographed image) to the bus 200 after receiving light information of an object by a sensor to perform A/D conversion. Details of the imaging parts 101 to 125 will be mentioned hereinafter. The flash 126 irradiates the object with light. A digital signal processing part 201 performs demosaicing processing, white balance processing, gamma processing, noise reduction processing, etc. on the photographed image data. Reference numeral 202 denotes a compression/elongation part, which performs processing of converting the photographed image data into file formats, such as JPEG and MPEG. Reference numeral 203 denotes an external memory control part. Reference numeral 204 denotes external media (for example, a hard disk, a memory card, a CF card, an SD card, and a USB memory). The external memory control part 203 is an interface for connecting to the external media 204. Reference numeral 205 denotes a CG generation part, which generates a GUI including texts and graphics, superimposes it on the photographed image data generated by the digital signal processing part 201, and generates new photographed image data. Reference numeral 206 denotes a display part, which shows a user various information such as setting of an imaging apparatus and photographed image data. Reference numeral 207 denotes a display control part, which displays on the display part 206 the photographed image data received from the CG generation part 205 and the digital signal processing part 201. Reference numeral 208 denotes an operation part, which corresponds to buttons, mode dials, etc., and generally includes a plurality of buttons and mode dials. Further, the display part 206 is configured as a touch panel, and may also serve as the operation part. A user's instruction is input through the operation part 208. Reference numeral 209 denotes an imaging optical system control part, which performs control of an imaging optical system, such as focusing, opening and closing of a shutter, adjustment of a diaphragm. Reference numeral 210 denotes a CPU, which executes various processing according to a command. Reference numeral 211 denotes a storage part, which stores the command etc. to be executed by the CPU 210. Reference numeral 212 denotes a principal object extraction part, which extracts a principal object from objects included in a photographing range of the imaging parts 101 to 125. Reference numeral 213 denotes a super-resolution capability calculation part, which calculates a capability of super-resolution processing in an image region where the principal object appears in a photographed image. Reference numeral 214 denotes an imaging parameter adjustment part, which adjusts an imaging parameter which will be described hereinafter according to the super-resolution capability calculated by the super-resolution capability calculation part 213. Reference numeral 215 denotes an image synthesis part, which focuses on an object located within a synthetic focal distance by synthesizing a photographed image group, and generates synthetic image data obtained by performing super-resolution processing on the image region in which the object located within the synthetic focal distance appears.

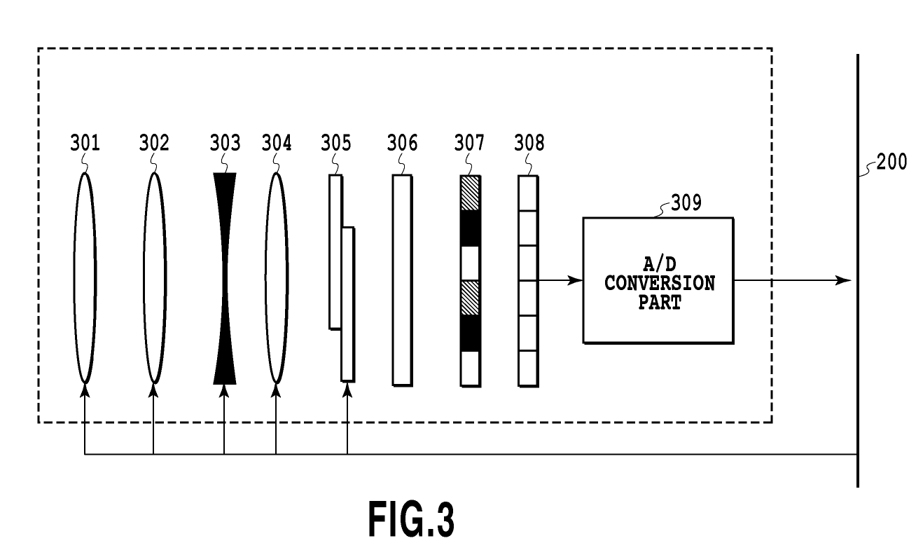

Here, details of the imaging parts 101 to 125 will be described with reference to FIG. 3. Reference numeral 301 denotes a focus lens group, which adjusts a photographing focal distance by moving back and forth on an optical axis. Reference numeral 302 denotes a zoom lens group, which changes optical focal distances of the imaging parts 101 to 125 by moving back and forth on the optical axis. Reference numeral 303 denotes a diaphragm, which adjusts an amount of light from the object. Reference numeral 304 denotes a fixed lens group, which is the lens for improving lens performance, such as telecentricity. Reference numeral 305 denotes a shutter. Reference numeral 306 denotes an IR cut filter, which absorbs an infrared ray from the object. Reference numeral 307 denotes a color filter, which transmits only light in a specific wavelength region.

Reference numeral 308 denotes a sensor, such as a CMOS and a CCD, which converts the amount of light from the object into an analog signal. Reference numeral 309 denotes an A/D conversion part, which converts the analog signal generated by the sensor 308 into a digital signal to generate photographed image data.

It is to be noted that an arrangement of the focus lens group 301, the zoom lens group 302, the diaphragm 303, and the fixed lens group 304 shown in FIG. 3 is an example, and that it may be a different arrangement and does not limit the present invention to this example. In addition, although the imaging parts 101 to 125 have been collectively described here, all the imaging parts do not necessarily need to have a same configuration. For example, some or all of the imaging parts may be a single focus optical system without the zoom lens group 302. Similarly, some or all of the imaging parts need not to have the fixed lens group 304. The above is the details of the imaging parts 101 to 125.

It is to be noted that although there exist components of the imaging apparatus other than the above, a description thereof will be omitted since they are not a thrust of the invention.

In addition, the components of the invention may be applied to a system including a plurality of devices, or may be applied to an apparatus including one device. The object of the present invention is achieved even if a computer (or a CPU or an MPU) of a system executes a program which achieves functions of the above-mentioned embodiment. In this case, the program itself achieves the functions of the above-mentioned embodiment, and a storage medium which has stored the program configures the present invention. As the storage medium for supplying a program code, for example, can be used a floppy disk, a hard disk, an optical disk, a magneto optical disk, a CD-ROM, a CD-R, a magnetic tape, a nonvolatile data storage part, a ROM, etc. In addition, it is not only the functions of the above-mentioned embodiment that is achieved by executing the program read by the computer. It is needless to say that a case is also included where an OS etc. running on the computer perform a part of actual processing based on an instruction of the program, and the functions of the above-mentioned embodiment is achieved by the processing. Further, it is needless to say that a case is also included where a CPU etc. included in a function expansion board of the system execute an instruction content of the program, and the functions of the above-mentioned embodiment is achieved by the processing.

### <Flow Chart of Embodiment 1>

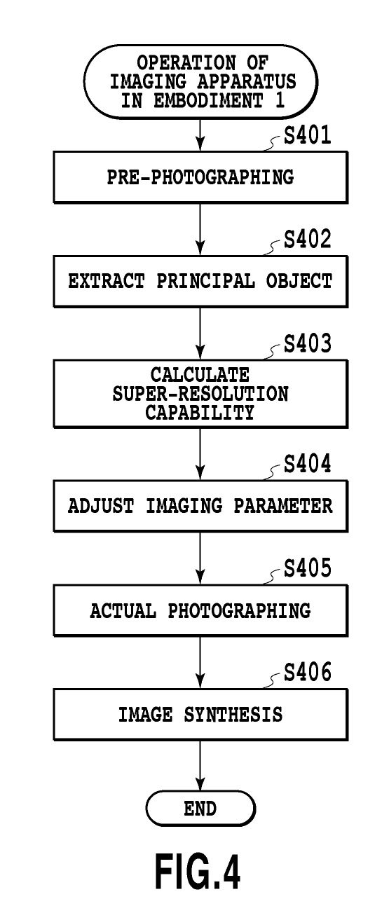

Operations of the imaging apparatus in the embodiment 1 will be described using a flow chart of FIG. 4.

In step S401, the imaging parts 101 to 125 perform pre-photographing.

In step S402, the principal object extraction part 212 extracts a principal object from pre-photographed image data photographed in step S401. Although an extraction method of the principal object is arbitrary, for example, a human face may be recognized from the pre-photographed image data and the recognized human face may be extracted as the principal object. Alternatively, the principal object may be extracted based on a size, an arrangement, a distance, a shape, etc. of the recognized object from the pre-photographed image data. Further, the pre-photographed image data may be displayed on the display part 206 (or the operation part 208), which is the touch panel, and an object selected by a user may be set as the principal object. Here, an object extracted as a principal object is not limited to one object, and a plurality of objects may be extracted as the principal objects.

In step S403, the super-resolution capability calculation part 213 calculates a super-resolution capability when a distance to the principal object extracted in step S402 is set as a synthetic focal distance. The super-resolution capability is a value indicating levels of a pixel shift amount which will be described hereinafter and a noise amplification amount generated in super-resolution processing, etc. When a plurality of principal objects is extracted in step S402, a super-resolution capability of the each principal object is calculated. Details of operations of the super-resolution capability calculation part 213 will be described hereinafter.

In step S404, the imaging parameter adjustment part 214 adjusts an imaging parameter based on the super-resolution capability calculated in step S403. Details of operations of the imaging parameter and the imaging parameter adjustment part 214 will be described hereinafter.

In step S405, the imaging parts 101 to 125 perform actual photographing using the imaging parameter adjusted in step S404.

In step S406, the image synthesis part 215 performs image synthesis processing of the photographed image data obtained by the actual photographing. A synthetic focal distance for the image synthesis processing is specified according to a user's instruction. Alternatively, the synthetic focal distance can be specified by an arbitrary method, such as being defined according to the principal object extracted in S402. Details of operations of the image synthesis part 215 will be described hereinafter.

### <Summary of Image Synthesis Part 215>

First will be described operations of the image synthesis part 215 as a premise of the present invention. The image synthesis part 215 changes a distance to a focused object from a photographing focal distance to a synthetic focal distance by synthesizing the photographed image group obtained by the imaging parts 101 to 125, and further, generates synthetic image data in which resolution of an image of an object within the synthetic focal distance has been improved.

### <Flow of Operations of Image Synthesis Part 215>

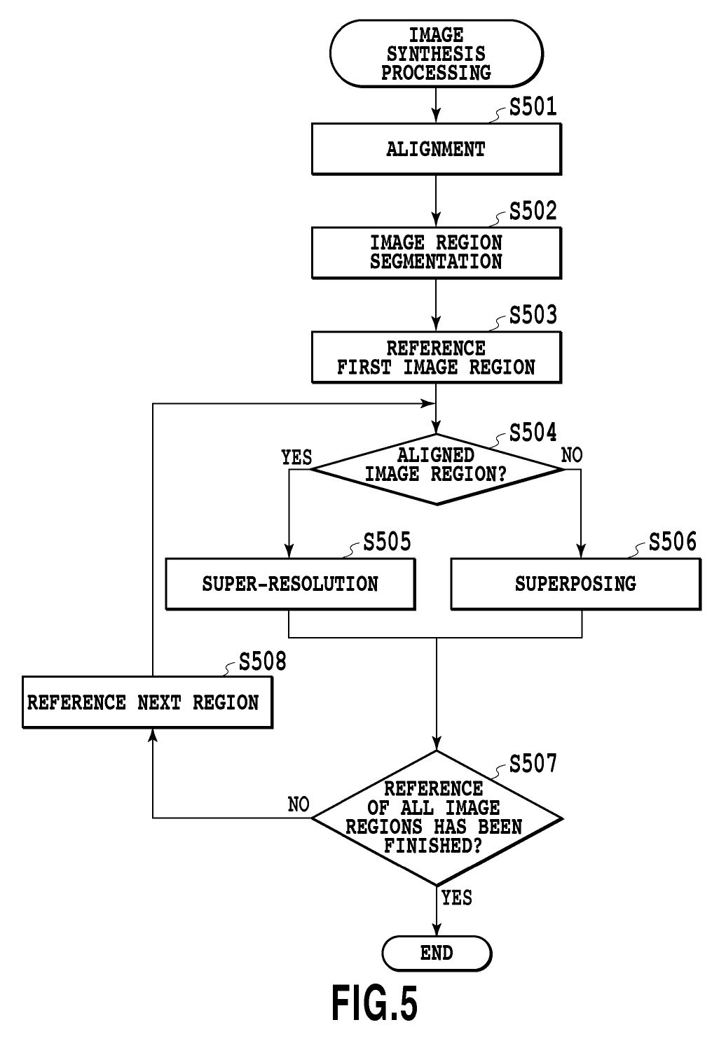

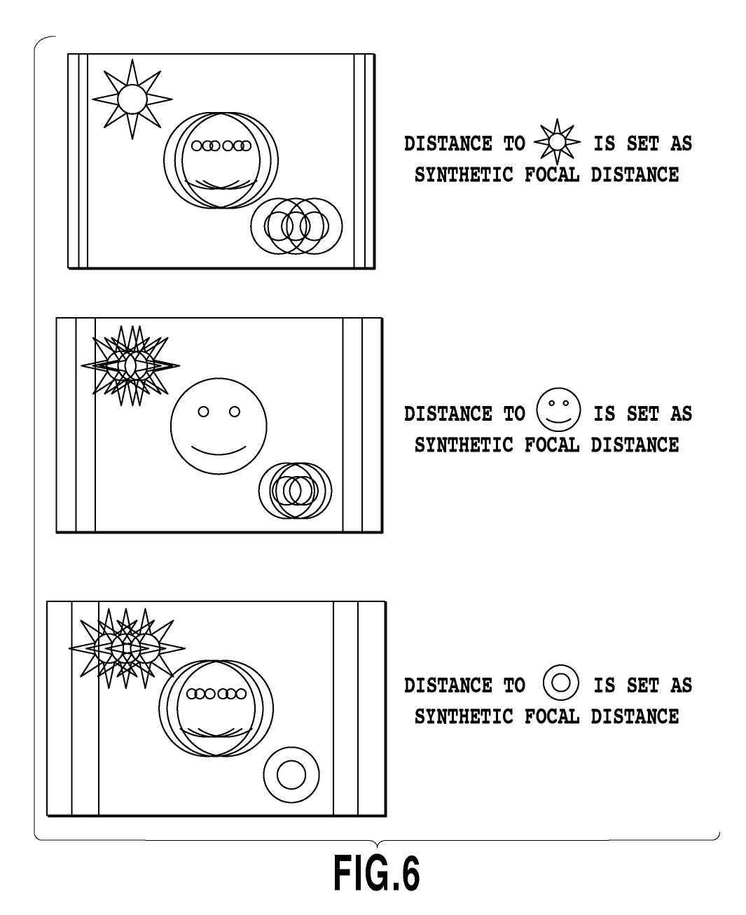

Operations of the image synthesis part 215 will be described using a flow chart of FIG. 5. In step S501, alignment processing which will be described hereinafter is performed on the plurality of photographed image data imaged by the plurality of imaging parts. When the alignment processing is performed, as shown in FIG. 6, in the plurality of photographed image data, image regions where the object located within the synthetic focal distance appears are aligned, and the other image regions are displaced.

In step S502, a photographed image is segmented into a plurality of image regions. Although a segmentation method is arbitrary, for example, the photographed image may be segmented into 8 by 8 pixel image region.

In step S503, a first image region is referenced (hereinafter a currently referencing image region is referred to as a “reference image region”). Although a selection method of the first reference image region is arbitrary, for example, an uppermost left image region may be selected as the first reference image region.

In step S504, it is determined whether or not the reference image region is the region aligned in S501. Although a determination method is arbitrary, for example, dispersion of color signals in the reference image region of a photographed image group is examined, and when the dispersion is small, the reference image region may be determined to be aligned, and when the dispersion is large, the reference image region may be determined to be misaligned.

When the reference image region is determined to be the aligned image region in step S504, super-resolution processing is performed on the image region in step S505. The super-resolution processing is the processing which restores degradation due to pixel shift, downsampling, and blurring. Although it is arbitrary what kind of super-resolution processing is performed, for example, may be used a method described in “Super-Resolution Image reconstruction: A Technical Overview”, Sung C. P., Min K. P., IEEE Signal Proc. Magazine, Vol. 26, 3, p. 21-36 (2003). Resolution of an image of the object located within the synthetic focal distance can be improved by performing super-resolution processing on the aligned image region.

When the reference image region is determined to be the misaligned image region in step S504, superposing processing is performed on the image region in step S506. Although it is arbitrary what kind of superposing processing is performed, for example, an average value of pixel values in the reference image region of the photographed image group may be used as a pixel value of the synthetic image data. Objects located beyond the synthetic focal distance can be blurred by the superposing processing.

If it is determined whether or not reference of all the image regions has been finished, and the reference thereof has not been finished yet in step S507, a next image region is referenced in step S508, and processing of steps S504 to S508 is repeated until reference of all the image regions is finished. Here, although a selection method of the next reference image region is arbitrary, for example, the next reference image region may be selected in raster order.

Due to the above processing, a distance to a focused object can be changed from the photographing focal distance to the synthetic focal distance, and further, can be generated the synthetic image data in which resolution of an image of the object located within the synthetic focal distance has been improved.

### <Flow of Alignment Processing>

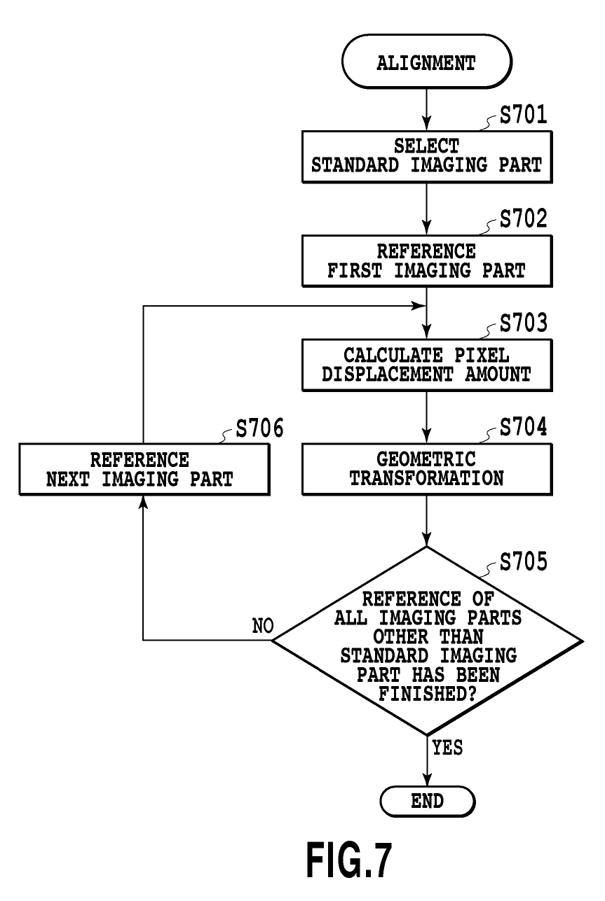

Alignment processing by the image synthesis part 215 will be described using a flow chart of FIG. 7.

In step S701, an imaging part used as a standard (hereinafter referred to as a standard imaging part) is selected. Although a selection method of the standard imaging part is arbitrary, for example, an imaging part closest to a center of gravity of each position of the imaging parts 101 to 125 may be selected as the standard imaging part.

In step S702, a first imaging part is referenced (hereinafter a currently referencing imaging part is referred to as a “reference imaging part”). Imaging parts which can be selected as the first reference imaging part are arbitrary imaging parts other than the standard imaging part. For example, an imaging part closest to the standard imaging part may be selected as the first reference imaging part.

In step S703, calculated is a pixel shift amount in a predetermined synthetic focal distance between photographed image data obtained by the standard imaging part (hereinafter referred to as standard photographed image data) and photographed image data obtained by the reference imaging part (hereinafter referred to as reference photographed image data). A distance to a position where alignment is performed is set as the predetermined synthetic focal distance. A calculation method of a pixel shift amount will be mentioned hereinafter.

In step S704, the reference photographed image data is geometrically transformed according to the pixel shift amount calculated in step S703. Here, since the pixel shift amount differs depending on a distance, the reference photographed image data is aligned in the synthetic focal distance and is displaced in the other distances by geometrically transforming the reference photographed image data according to the pixel shift amount in the synthetic focal distance.

If it is determined whether or not reference of all the imaging parts other than the standard imaging part has been finished, and the reference has not been finished yet in step S705, a next photographing part is referenced in step S706, and processing of steps S703 to S706 is repeated until the reference of all the imaging parts is finished. Here, although a selection method of the next reference imaging part is arbitrary, for example, an imaging part closest to the standard imaging part of the imaging parts, which have not been referenced yet, other than the standard photographing part may be selected as the next reference imaging part.

### <Calculation Method of Pixel Shift Amount>

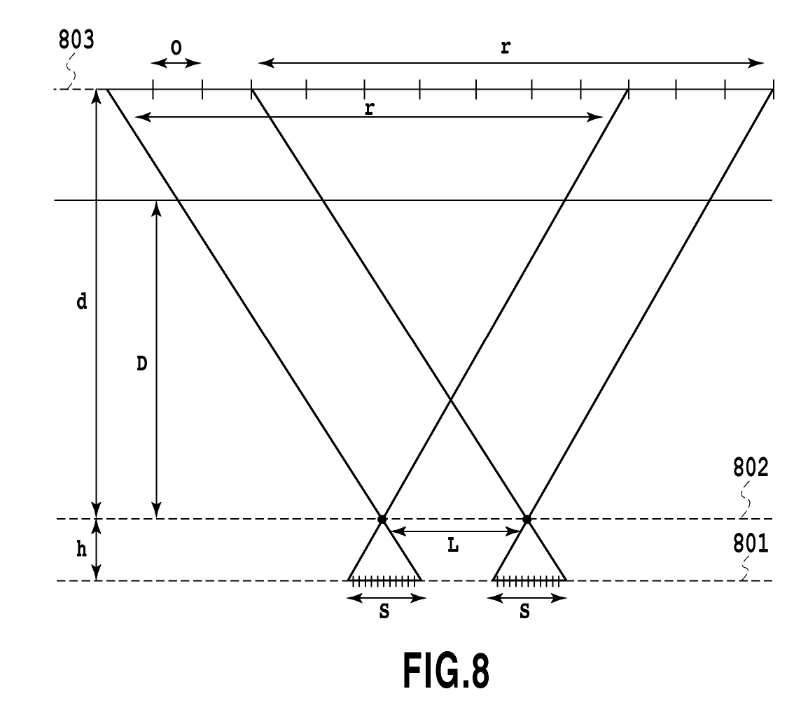

A calculation method of a pixel shift amount by the image synthesis part 215 will be described using FIG. 8 schematically showing a scale relation between the sensor 308 and an object.

In FIG. 8, a sensor plane 801 is the plane on which the sensor 308 of each of the imaging parts 101 to 125 is placed. The lens plane 802 is the plane including all optical centers of the imaging parts 101 to 125. A synthetic focal plane 803 is the plane located within a synthetic focal distance (distance to a target object for which a pixel shift amount is calculated). In addition, d denotes the synthetic focal distance, and D denotes a photographing focal distance. h denotes a distance between the sensor plane 801 and the lens plane 802 (hereinafter referred to as a sensor-to-lens distance). L denotes a distance in an x direction between an optical center of a standard imaging part and an optical center of a reference imaging part (hereinafter referred to as a base length). s denotes a length of the sensor 308 in the x direction. r denotes a length in the x direction in a range imaged by all the pixels of the sensor 308 in the synthetic focal plane 803, and o denotes a length in the x direction in a range imaged by 1 pixel of the sensor 308 in the synthetic focal plane 803. Here, the “x direction” indicates the direction shown in FIG. 1.

As a simple example, an ideal case is considered where the imaging parts 101 to 125 are arranged so as to overlap with mutual imaging parts by parallel movement on a plane vertical to optical axes of the imaging parts 101 to 125, and a distortion aberration of individual photographed image data, etc. are small enough to be able to be ignored. Further, assume that all the imaging parts 101 to 125 have a same optical focal distance f, and that a pixel pitch s′ in the x direction and the number of pixels n in the x direction of the sensor 308 are the same as each other (here, it holds that s=s′×n). At this time, since pixel shift occurs only in the parallel movement, a calculation method is indicated by considering an amount of the parallel movement as a pixel shift amount. A pixel shift amount a in the x direction can be expressed by Expressions (1) to (3) from FIG. 8.

$$\begin{matrix}[ Expression 1 ] & \\ a = \frac{L}{o} & ( 1 ) \\ [ Expression 2 ] & \\ o = \frac{r}{n} & ( 2 ) \\ [ Expression 3 ] & \\ r = \frac{s \cdot d}{h} & ( 3 )\end{matrix}$$

In addition, a relation of the optical focal distance f, the photographing focal distance D, and the sensor-to-lens distance h can be expressed by Expression (4).

$$\begin{matrix}[ Expression 4 ] & \\ \frac{1}{D} + \frac{1}{h} = \frac{1}{f} & ( 4 )\end{matrix}$$

When taken together, the pixel shift amount a in the x direction can be expressed by Expression (5).

$$\begin{matrix}[ Expression 5 ] & \\ a = \frac{L \cdot D \cdot f}{d \cdot {s}^{′} ( D - f )} & ( 5 )\end{matrix}$$

Although the above description is for the calculation method of the pixel shift amount in the x direction, a pixel shift amount in a y direction may be similarly calculated.

Although the above is a simple example of the calculation method of the pixel shift amount, in a more general case, for example, when positions and attitudes of the imaging parts 101 to 125 are arbitrary, and optical focal distances and pixel pitches are different from each other, the pixel shift amount depends on a pixel position in the photographed image data. Hence, as in the above-mentioned example, a pixel shift amount is not calculated in the entire photographed image data, but is locally calculated. Specifically, calculated is which pixel position a point which appears on pixel positions x and y of the photographed image data obtained by the reference imaging part, and which is located within the synthetic focal distance corresponds to on the photographed data obtained by the standard imaging part. Perspective projection transformation and the inverse transformation may be used for the calculation. Since the perspective projection transformation is not a thrust of the invention, a description thereof will be omitted. In addition, when individual photographed image data has a distortion aberration, a correspondence relation may be calculated as correspondence of the pixel positions after distortion correction is performed. Since the distortion correction may be performed using existing technology, and it is not the thrust of the invention, a description thereof will be omitted.

### <Operations of Super-resolution Capability Calculation Part 213>

Operations of the super-resolution capability calculation part 213 will be described. If there is no pixel shift of sub-pixels between photographed image data, it is impossible to perform super-resolution processing. In addition, although it is possible to perform super-resolution processing itself if a pixel shift amount is away from an integer value even slightly, noise is amplified when shift from the integer value is small. Consequently, an index E indicating a super-resolution capability is defined by the pixel shift amount as in Expression (6).

[Expression 6]

E=|a−round(a)| (6)

Here, a indicates a pixel shift amount with the standard photographed image data, and round (a) indicates a value obtained by rounding off a. The calculation method of the pixel shift amount a is as mentioned above.

In addition, as in Expression (7), the index E indicating the super-resolution capability may be defined as a value correlated with a noise amplification amount generated in the super-resolution processing.

$$\begin{matrix}[ Expression 7 ] & \\ E = {\sum }_{l m} {\vert {X}_{( [ N / 2 ] [ N / 2 ] ) ( l m )} \vert}^{2} & ( 7 )\end{matrix}$$

Here, X denotes an inverse matrix of a matrix M whose component is expressed by the following Expression.

[Expression 8]

M₍ⱼₖ₎₍ₗₘ₎=exp {i2π((j−[N/2])Δxₗ+(k−[N/2])Δyₘ)} (8)

Here, j and k, and l and m are values from 1 to N, respectively, and N denotes the number of pieces of input image data used for image synthesis. In addition, Δxₗ and Δyₘ, denote pixel shift amounts in the x direction and the y direction, respectively. In addition, [N/2] is a Gauss symbol, and indicates an integer not exceeding N/2. A size of the matrix M is N² by N².

It is to be noted that the index E indicating the super-resolution capability is not limited to the value correlated with the above-described pixel shift amounts or noise amplification amounts. Since super-resolution processing is technology which restores not only pixel shift but degradation due to downsampling or blurring, the super-resolution capability depends also on a sensor resolution and an MTF of a lens. Generally, since the higher the sensor resolution is, the higher the super-resolution capability is, and the higher the MTF of the lens is, the higher the super-resolution capability is, the index E indicating the super-resolution capability may be set as a value correlated with the sensor resolution or the MTF of the lens.

### <Operations of Imaging Parameter Adjustment Part 214>

Operations of an imaging parameter adjustment part 214 will be described. The imaging parameter adjustment part 214 adjusts an imaging parameter so that a super-resolution capability is high when a distance to a principal object is set as a synthetic focal distance. Here, the imaging parameter means: a photographing focal distance; a sensor-to-lens distance; a optical focal distance; a base length; a sensor pixel pitch; a position of a sensor; a position of an optical lens; a sensor resolution; and an MTF of the lens. It is to be noted that although a calculation method of the distance to the principal object is arbitrary, for example, a principle of a stereoscopic view may be used. Since the principle of the stereoscopic view is not a thrust of the invention, a description thereof will be omitted.

A specific adjustment method of an imaging parameter will be described. As a simple example, a case is considered where there are only a total of two imaging parts of one standard imaging part and one reference imaging part, and is only one principal object.

First, adjustment of a photographing focal distance will be described as a most desirable adjustment method. When Expression (6) is used as the index E indicating a super-resolution capability, an adjustment amount Δa of a pixel shift amount which maximizes the super-resolution capability can be expressed by Expression (9).

[Expression 9]

Δa=0.5−(a−floor(a)) (9)

Here, floor (a) means round-down of a in an infinitesimal direction.

An adjustment amount ΔD of a photographing focal distance when the pixel shift amount is desired to be changed by Δa can be expressed as Expression (10) by transforming Expression (5).

$$\begin{matrix}[ Expression 10 ] & \\ Δ D = \frac{Δ a \cdot d \cdot {s}^{′} \cdot f}{Δ a \cdot d \cdot {s}^{′} - L \cdot f} & ( 10 )\end{matrix}$$

Here, since fixing the optical focal distance f to change the photographing focal distance D is equivalent to changing the sensor-to-lens distance h from Expression (4), it is also possible to adjust the pixel shift amount a by adjusting the sensor-to-lens distance h. Although the above is the simple example of adjusting the imaging parameter, actually, it is necessary to adjust the imaging parameter so that all the reference imaging parts and all the principal objects have optimal super-resolution capabilities. Although a policy of optimization is arbitrary, for example, adjustment may be performed so that a sum of indexes E representing the super-resolution capabilities of all the principal objects and all the reference photographed image data becomes a maximum.

Although the pixel shift amount a is adjusted by adjusting the photographing focal distance or the sensor-to-lens distance in the above description, imaging parameters other than the photographing focal distance may be adjusted based on Expression (5). For example, if the optical focal distance f is adjusted, the pixel shift amount a can be adjusted although an angle of view also changes together. In addition, if used is a camera array in which the imaging parts 101 to 125 can be freely moved parallel, the pixel shift amount a may be adjusted by changing the base length L. In addition, the pixel shift amount a may be adjusted by changing the pixel pitch s′ using a method for transforming the sensor 308 with heat, etc. In addition, optical lenses 301, 303, and 304 and the sensor 308 may be moved parallel according to the adjustment amount Δa of the pixel shift amount. The parallel movement amount p can be expressed by Expression (11).

[Expression 11]

p=s′·Δa (11)

In addition, a sensor resolution and a lens MTF may be adjusted to enhance a super-resolution capability by changing a sensor to a sensor with a high resolution, or changing a lens to a lens with a high MTF.

It is to be noted that the imaging parameter to be adjusted is not limited to a single one, and that a plurality of imaging parameters may be adjusted simultaneously.

As described above, according to the embodiment 1, by adjusting the imaging parameter, can be enhanced the super-resolution capability when the distance to the principal object is set as the synthetic focal distance.

### Embodiment 2

In the embodiment 1, the example has been described where the imaging parameter is adjusted so as to enhance the super-resolution capability when the distance to the principal object is set as the synthetic focal distance. In an embodiment 2, an example will be shown where warning display is performed to a user according to a super-resolution capability when a distance to a principal object is set as a synthetic focal distance.

### <Flow Chart of Embodiment 2>

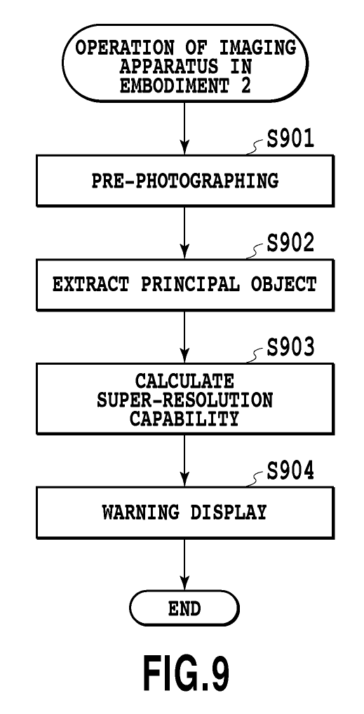

Operations of an imaging apparatus in the embodiment 2 will be described using a flow chart of FIG. 9. Since steps S901 to S903 are the same as steps S401 to S403 in the embodiment 1, a description thereof will be omitted.

In step S904, the display part 206 performs warning display according to the super-resolution capability calculated in step S903. Operations of the display part 206 will be mentioned hereinafter.

### <Operations of Display Part 206>

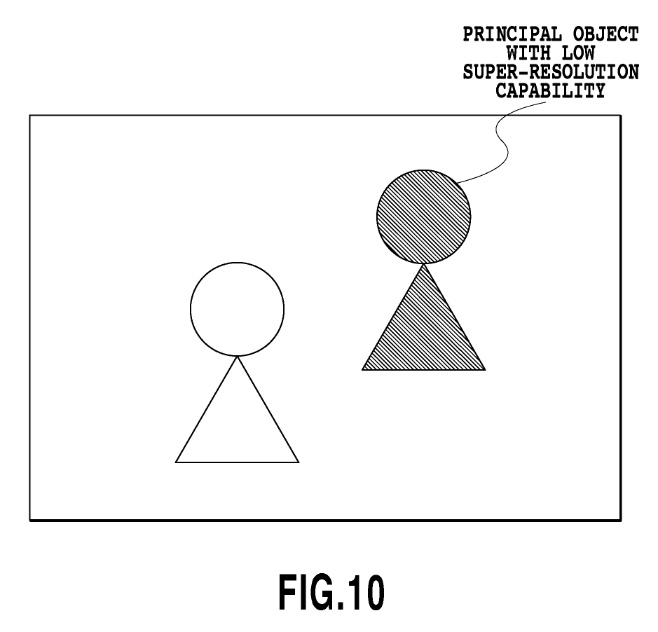

Operations of the display part 206 will be described. The display part 206 performs warning display according to the super-resolution capability calculated by the super-resolution capability calculation part 213. Although conditions to perform the warning display are arbitrary, warning display may be performed, for example, when a threshold of the index E indicating the super-resolution capability, and there is a principal object for which the index E is less than the threshold. Here, when the index E is defined by Expression (6), for example, a value 0.1 can be set as the threshold. It is to be noted that although a content of warning display is arbitrary, for example, the principal object for which the index E is less than the threshold may be highlighted as shown in FIG. 10. In addition, may be displayed a text for informing that there is a principal object on which super-resolution cannot be performed. According to the above operations, a user can confirm whether or not super-resolution can be performed when the synthetic focal distance is set for the principal object. As a result of this, for example, when an object for which the user want to synthesize focused image data after photographing has a low super-resolution capability, it becomes possible to promote adjustment of an imaging parameter by the user himself/herself. After the imaging parameter is adjusted, actual photographing and image synthesis are performed similarly to the embodiment 1.

As described above, according to the embodiment 2, a user can confirm whether or not super-resolution can be performed when the synthetic focal distance is set for the principal object by performing the warning display according to the super-resolution capability.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-119078, filed May 27, 2011, which is hereby incorporated by reference herein in its entirety.

What is claimed is:

1. An imaging apparatus, comprising:
a plurality of imaging units configured to perform photographing from a plurality of different viewpoints;
an extracting unit configured to extract a principal object from images imaged by the imaging units;
a calculating unit configured to calculate a super-resolution capability for the extracted principal object; and
an adjusting unit configured to adjust an imaging parameter according to the calculated super-resolution capability.

2. The imaging apparatus according to claim 1, wherein the imaging parameter includes at least anyone of: a photographing focal distance; a sensor-to-lens distance; a optical focal distance; a base length; a sensor pixel pitch; a position of sensor; a position of optical lens; a sensor resolution; and an MTF of lens, of the imaging unit.

3. The imaging apparatus according to claim 1, wherein the extracting unit extracts a principal object by recognizing a human face from the images imaged by the imaging unit.

4. The imaging apparatus according to claim 1, wherein the extracting unit extracts a principal object from the images imaged by the imaging unit according to user's selection.

5. The imaging apparatus according to claim 1, wherein the super-resolution capability is a value indicating a pixel shift amount between the images imaged by the imaging unit.

6. The imaging apparatus according to claim 1, wherein the super-resolution capability is a value indicating a level of a noise amplification amount generated when super-resolution processing is performed.

7. The imaging apparatus according to claim 1, wherein the super-resolution capability is a value correlated with a sensor resolution.

8. The imaging apparatus according to claim 1, wherein the super-resolution capability is a value correlated with an MTF of a lens.

9. The imaging apparatus according to claim 1, comprising a display unit configured to perform warning display to a user according to the calculated super-resolution capability.

10. The imaging apparatus according to claim 9, wherein the warning display is highlighting of a principal object for which a super-resolution capability is less than a predetermined threshold.

11. The imaging apparatus according to claim 10, wherein the warning display is display of a text indicating that there is a principal object for which a super-resolution capability is less than a predetermined threshold, and on which super-resolution cannot be performed.

12. An imaging method, comprising:
a plurality of imaging steps of performing photographing from a plurality of different viewpoints;
an extracting step of extracting a principal object from images imaged by the imaging steps;
a calculating step of calculating a super-resolution capability for the extracted principal object; and
an adjusting step of adjusting an imaging parameter according to the calculated super-resolution capability.

13. A computer-readable recording medium having computer-executable instructions for performing an image processing method comprising:
a plurality of imaging steps of performing photographing from a plurality of different viewpoints;
an extracting step of extracting a principal object from images imaged by the imaging steps;
a calculating step of calculating a super-resolution capability for the extracted principal object; and
an adjusting step of adjusting an imaging parameter according to the calculated super-resolution capability.
